(19) United States
(12) Patent Application Publication
(10) Pub. No.: US 2016/0247048 A1
(43) Pub. Date: Aug. 25, 2016

(54) PRINT JOB RE-PREFLIGHT MECHANISM

(71) Applicants: David Ward, Broomfield, CO (US); Katie Ashley Eng, Boulder, CO (US); Aritra Bandyopadhyay, Boulder, CO (US)

(72) Inventors: David Ward, Broomfield, CO (US); Katie Ashley Eng, Boulder, CO (US); Aritra Bandyopadhyay, Boulder, CO (US)

(73) Assignee: Ricoh Company, Ltd., Tokyo (JP)

(21) Appl. No.: 14/629,846

(22) Filed: Feb. 24, 2015

(51) Int. Cl. G06K 15/02

(52) U.S. Cl. CPC G06K 15/1806

(57) ABSTRACT

A method is disclosed. The method includes receiving print job data at a printing system, performing a first preflight of the print job data to collect job attribute data, detecting that one or more changes have been made to the print job data and performing a second preflight of the print job data using the job attribute data collected during the first preflight based on the one or more changes.

### FIELD OF THE INVENTION

The invention relates to the field of printing systems, and in particular, to processing print jobs at a printing system.

### BACKGROUND

In the field of printing, users prefer systems that allow for flexible processing of print jobs, which typically comprise print data (e.g., a job data stream used to generate a printed output) as well as a job ticket. The job ticket includes attributes that assist in defining processing steps that may be performed for the print job. Typically, job attributes (e.g., media, finishing, layout, etc.) are collected from the data stream and associated job ticket during a pre-processing phase of receiving a job. This process is commonly referred to as job preflight.

Preflight information is useful to decide whether to make a job eligible for printing if all media found during preflight is available in physical printer trays. In addition, the information may be used to predict the time it will take to complete the job after it is submitted for processing. In some instances the user may decide after the job has been preflighted (e.g., at the completion of the preprocessing phase) to make changes to the job ticket before the job is released for processing. As a result, a recalculation of some or all the preflight data (re-preflight) must be performed.

A common approach to re-preflighting a job is to resubmit the data stream and an updated job ticket representing the merge of the original job ticket and the changes for pre-processing, which will force a replay of the entire job. This approach is not efficient since a re-preflight job must undergo pre-processing once again, thus re-performing calculations that may not be impacted by the change to the job ticket. For example, a 10 page duplex job with ‘Letter’ media in the job ticket will result in five ‘Letter’ sheets with two pages per sheet. If the ticket media is change to ‘A4’, the re-preflight change is simply renaming ‘Letter’ to ‘A4’. The layout information is unchanged (e.g., there are still five sheets and two pages per sheet).

Accordingly, a mechanism to re-prefight a print job, due to a job ticket change, without having to resubmit the job for pre-processing is desired.

### SUMMARY

In one embodiment, a method is disclosed. The method includes receiving print job data at a printing system, performing a first preflight of the print job data to collect job attribute data, detecting that one or more changes have been made to the print job data and performing a second preflight of the print job data using the job attribute data collected during the first preflight based on one or more changes.

### BRIEF DESCRIPTION OF THE DRAWINGS

A better understanding of the present invention can be obtained from the following detailed description in conjunction with the following drawings, in which:

FIG. 1 illustrates one embodiment of a printing system;

FIG. 2 is a flow diagram illustrating one embodiment of print process;

FIG. 3 is a flow diagram illustrating one embodiment of re-preflight process;

FIG. 4 illustrates re-preflight embodiments; and

FIG. 5 illustrates one embodiment of a computer system.

### DETAILED DESCRIPTION

A re-preflight mechanism is described. In the following description, for the purposes of explanation, numerous specific details are set forth in order to provide a thorough understanding of the present invention. It will be apparent, however, to one skilled in the art that the present invention may be practiced without some of these specific details. In other instances, well-known structures and devices are shown in block diagram form to avoid obscuring the underlying principles of the present invention.

Reference in the specification to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment.

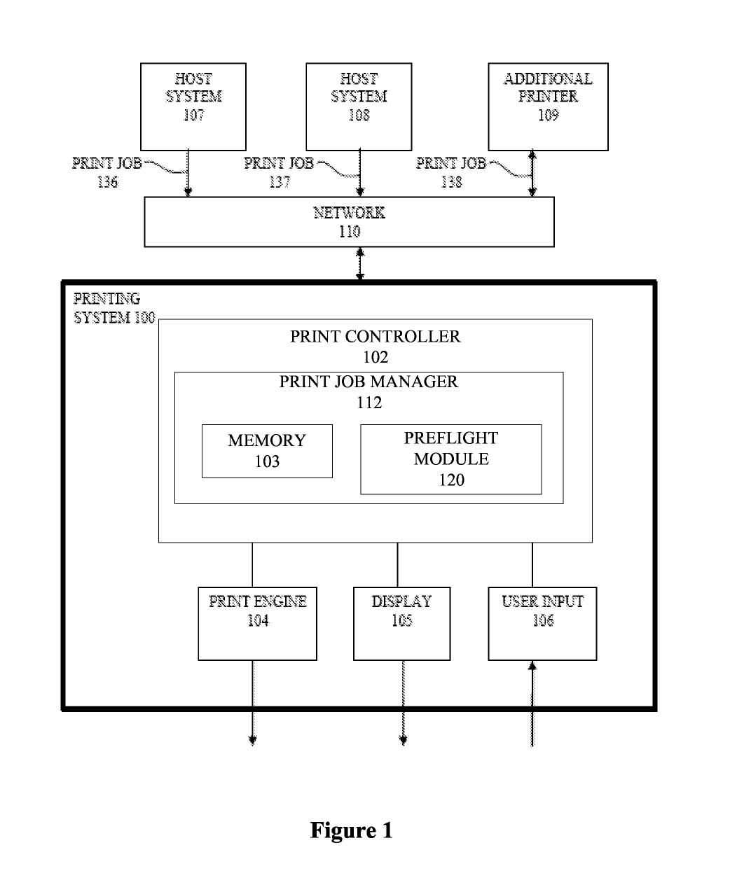

FIG. 1 is a block diagram illustrating one embodiment of a printing system 100. Printing system 100 is a system used to provide marks on a media, such as a continuous forms printer or a cut sheet page printer. Printing system 100 may include any digital hardcopy output device, such as printers, copiers, multifunction printers (MFPs) and facsimiles.

In one embodiment, printing system 100 is shared by multiple users. In such an embodiment, printing system 100 includes a print controller 102 and one or more print engines 104. Print controller 102 includes any system, server, or components operable to interface one or more host systems 107 and 108, and a printer 109, via network 110 with one or more print engines 104, and to control the printing of print jobs 136-138 received from the host systems 107 and 108, and a printer 109, respectively, on print engine 104. Print engine 104 provides an imaging process to mark a printable medium, such as paper.

According to one embodiment, print controller 102 includes memory 103 and a print job manager 112. Memory 103 includes any storage system operable to store data. In one embodiment, print job manager 112 manages the printing of documents at printing system 100. Particularly, print job manager 112 controls print jobs as they wait to print, arranges the priority of the print jobs, generates separator pages and distributes jobs to the destination print engine 104. In one embodiment, print job manager 112 may be implemented using either InfoPrint Manager (IPM) or InfoPrint ProcessDirector (IPPD), although other types of print job managers may be used instead.

In one embodiment, print job manager 112 holds received print jobs in memory 103 before processing the print job. In such an embodiment, memory 103 stores the print jobs as either a data file or rasterized file. For example, print jobs stored as rasterized files reduce print time for the held jobs versus those stored as data files. Once stored, each print job may be held until the user that generated the print job retrieves the corresponding document from printing system 100, at which time the print job is processed and printed.

In a further embodiment, a user may release a selected job for printing at printing system 100 via user input 106. Printing system 100 thereby processes the print job by printing via print engine 104. In still a further embodiment, multiple selected print jobs being held for a particular user may be simultaneously processed and printed at print engine 104. Therefore, all print jobs for the same user are printed together when multiple print jobs are released to print.

According to one embodiment, print job manager 112 includes a preflight module 120 that is implemented to collect job attribute data. In a further embodiment, preflight module 120 performs a subsequent preflight (or re-preflight) of a print job based on detected changes to the job ticket, without having to resubmit the entire job for pre-processing to recollect the job attribute data. In such an embodiment, pre-flight module 120 uses existing preflight data to determine re-preflight for job ticket changes (e.g., plex, media, nUpness, adding insert sheets before or after a page, etc.).

In a further embodiment, the existing preflight data is acted upon by a set of operations (e.g., insert, replace, split, join, fill, delete, shift to right, shift to left, etc.) for each detected change to determine the re-preflight data. Performing such operations on the existing preflight data is much more efficient and faster than resubmitting the job for preprocessing. In still a further embodiment, a job is resubmitted for pre-processing if the detected changes are not within the group of recognizable changes. In such an embodiment, unique data stream information that has been saved is not re-collected since any job ticket change will not impact existing data stream preflight data. In one embodiment, the unique data stream information includes pageSize, finishing information, printable area information, etc. Moreover, unique data stream information in the preflight data will be re-used to determine re-preflight layout information (sheets, sides, etc.).

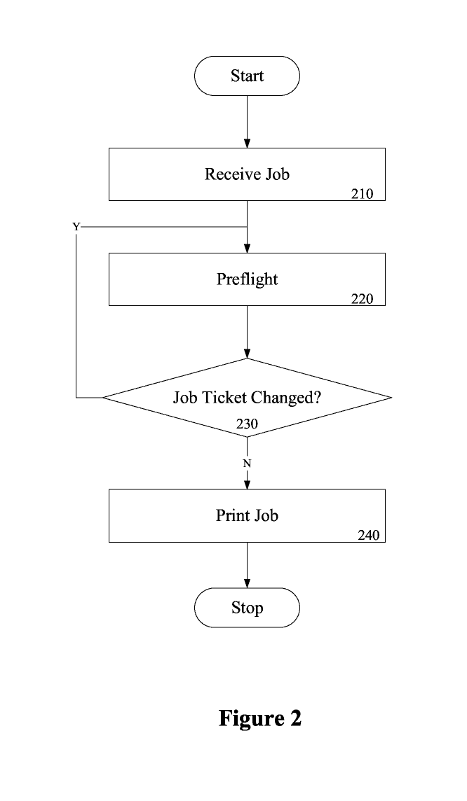

FIG. 2 is a flow diagram illustrating one embodiment of a printing process performed at print job manager 112. At processing block 210, a print job (e.g., the job data stream and job ticket) is received at print controller 102 for print processing. At processing block 220, pre-flight module 120 performs a preflight process by collecting job attributes. After pre-flight, but prior to processing the job, a printing system 100 operator may change the job ticket. Thus, at decision block 230, a determination is made as to whether the job ticket has been changed. If so, a subsequent preflight (or re-preflight) is performed.

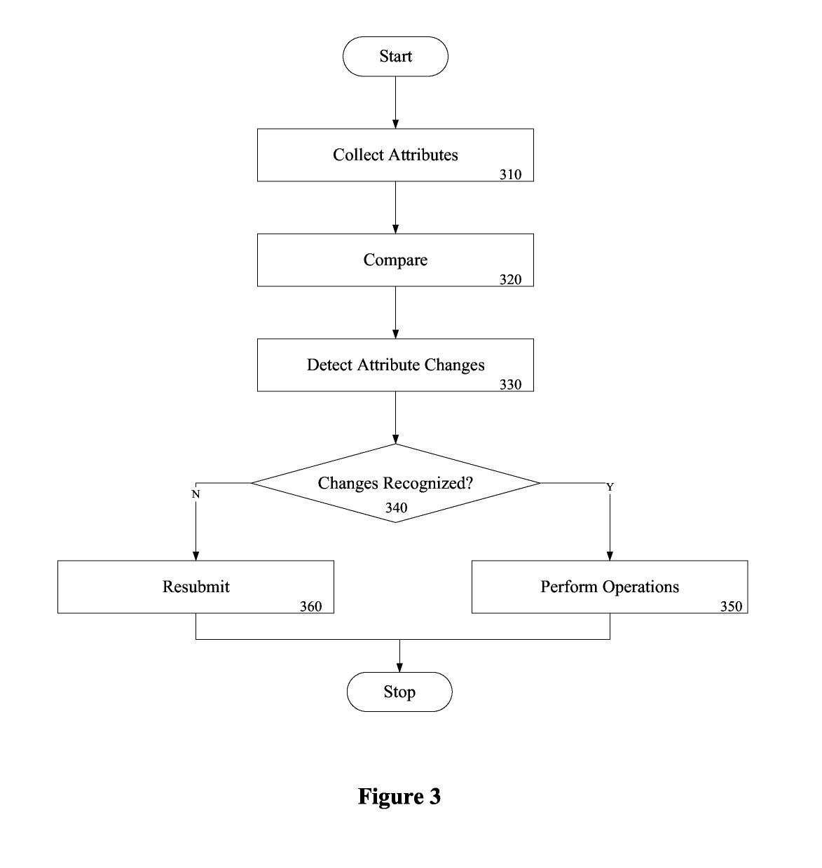

As discussed above, re-preflight is performed by using the existing preflight data to eliminate having to resubmit the entire job. FIG. 3 is a flow diagram illustrating one embodiment of a re-preflight process performed at preflight module 120. At processing block 310, attributes associated with the changed job ticket are collected. At processing block 320, the attributes collected from the changed job ticket are compared to attributes in the preflight data. At processing block 330, a change in one or more attributes in the changed job ticket is detected. At decision block 340, a determination is made as to whether the changes are recognizable.

If the changes are recognizable, an operation is performed for each attribute in the existing preflight data that has changed, processing block 350. However if the changes are not recognized, job is resubmitted for re-collection of attribute data, processing block 360. As discussed above, the unique data stream information is not re-collected since a job ticket change will not impact existing data stream preflight data.

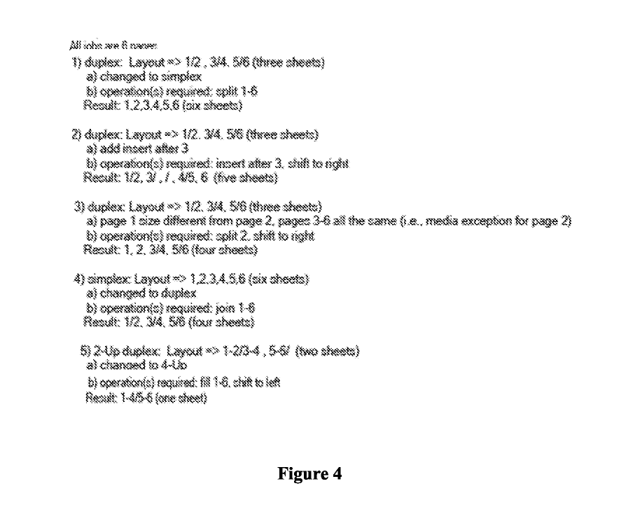

FIG. 4 illustrates exemplary embodiments of operations performed on a changed attribute during a re-preflight process. In each of the examples 1-5, a print job includes six pages and has a preflight attribute that has changed in the job ticket. Additionally, the examples show an operation that is performed to necessitate change of the attribute to reflect the changed job ticket. For instance, example 1 shows that a split operation is performed to change a duplex layout of six pages on three sheets to a simplex layout having six sheets.

Referring back to FIG. 2, control is returned to decision block 230 after the re-preflight process is performed to determine whether the job ticket has again been changed. If so, pre-flight is again performed. Otherwise, the job is processed and printed, processing block 240.

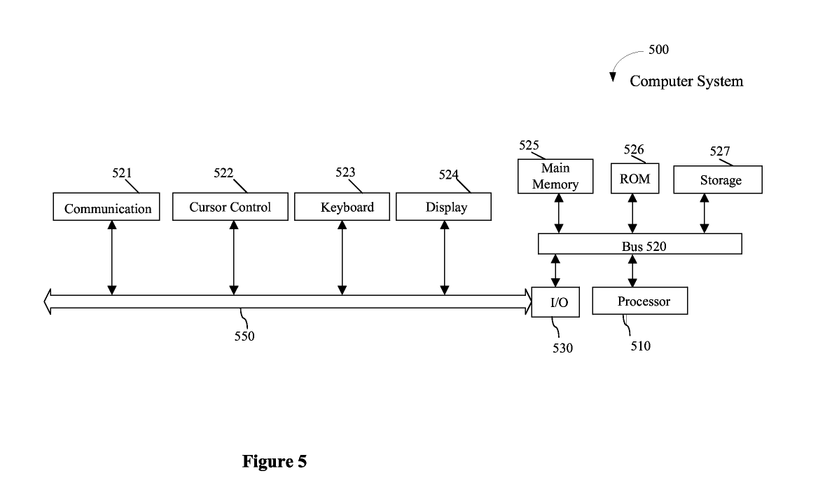

FIG. 5 illustrates a computer system 500 on which printing system 100 may be implemented. Computer system 500 includes a system bus 520 for communicating information, and a processor 510 coupled to bus 520 for processing information.

Computer system 500 further comprises a random access memory (RAM) or other dynamic storage device 527 (referred to herein as main memory), coupled to bus 520 for storing information and instructions to be executed by processor 510. Main memory 527 also may be used for storing temporary variables or other intermediate information during execution of instructions by processor 510. Computer system 500 also may include a read only memory (ROM) and or other static storage device 526 coupled to bus 520 for storing static information and instructions used by processor 510.

A data storage device 525 such as a magnetic disk or optical disc and its corresponding drive may also be coupled to computer system 500 for storing information and instructions. Computer system 500 can also be coupled to a second I/O bus 550 via an I/O interface 530. A plurality of I/O devices may be coupled to I/O bus 550, including a display device 524, an input device (e.g., an alphanumeric input device 523 and or a cursor control device 522). The communication device 521 is for accessing other computers (servers or clients). The communication device 521 may comprise a modem, a network interface card, or other well-known interface device, such as those used for coupling to Ethernet, token ring, or other types of networks.

Embodiments of the invention may include various steps as set forth above. The steps may be embodied in machine-executable instructions. The instructions can be used to cause a general-purpose or special-purpose processor to perform certain steps. Alternatively, these steps may be performed by specific hardware components that contain hardwired logic for performing the steps, or by any combination of programmed computer components and custom hardware components.

Elements of the present invention may also be provided as a machine-readable medium for storing the machine-executable instructions. The machine-readable medium may include, but is not limited to, floppy diskettes, optical disks, CD-ROMs, and magneto-optical disks, ROMs, RAMs, EPROMs, EEPROMs, magnetic or optical cards, propagation media or other type of media/machine-readable medium suitable for storing electronic instructions. For example, the present invention may be downloaded as a computer program which may be transferred from a remote computer (e.g., a server) to a requesting computer (e.g., a client) by way of data signals embodied in a carrier wave or other propagation medium via a communication link (e.g., a modem or network connection).

Whereas many alterations and modifications of the present invention will no doubt become apparent to a person of ordinary skill in the art after having read the foregoing description, it is to be understood that any particular embodiment shown and described by way of illustration is in no way intended to be considered limiting. Therefore, references to details of various embodiments are not intended to limit the scope of the claims, which in themselves recite only those features regarded as essential to the invention.

1. A non-transitory machine-readable medium including data that, when accessed by a machine, cause the machine to perform operations comprising:
receiving print job data at a printing system;
performing a first preflight of the print job data to collect job attribute data;
detecting that one or more changes have been made to the print job data; and
performing a second preflight of the print job data using the job attribute data collected during the first preflight based on the one or more changes.

2. The machine readable medium of claim 1 wherein the second preflight is performed without having to recollect the job attribute data.

3. The machine readable medium of claim 1 including data that, when accessed by the machine, further cause the machine to perform operations comprising determining whether a change is recognizable.

4. The machine readable medium of claim 3 including data that, when accessed by the machine, further cause the machine to perform operations comprising performing a set of operations on the job attribute data collected during the first preflight to determine data for the second preflight upon determining that the change is recognizable.

5. The machine readable medium of claim 3 including data that, when accessed by the machine, further cause the machine to perform operations comprising resubmitting the print job data to re-collect the job attribute data upon determining that the change is not recognizable.

6. The machine readable medium of claim 5 wherein unique data stream information is not re-collected.

7. The machine readable medium of claim 6 wherein the unique data stream information is re-used to determine re-preflight layout information.

8. The machine readable medium of claim 1 wherein detecting that one or more changes comprises detecting a change in a job ticket.

9. A printing system comprising:
a storage device;
a print job manager to store received print jobs in the storage device; and
an preflight module to perform a first preflight of the print job data to collect job attribute data, detect that one or more changes have been made to the print job data, and perform a second preflight of the print job data using the job attribute data collected during the first preflight based on the one or more changes.

10. The printing system of claim 9 wherein the second preflight is performed without having to recollect the job attribute data.

11. The printing system of claim 9 wherein the preflight module
determines whether a change is recognizable.

12. The printing system of claim 11 wherein the preflight module performs a set of operations on the job attribute data collected during the first preflight to determine data for the second preflight upon determining that the change is recognizable.

13. The printing system of claim 11 wherein the preflight module resubmits the print job data to re-collect the job attribute data upon determining that the change is not recognizable.

14. The printing system of claim 13 wherein unique data stream information is not re-collected.

15. The printing system of claim 14 wherein the unique data stream information is re-used to determine re-preflight layout information.

16. The printing system of claim 9 wherein detecting that one or more changes comprises detecting a change in a job ticket.

17. A method comprising:
receiving print job data at a printing system;
performing a first preflight of the print job data to collect job attribute data;
detecting that one or more changes have been made to the print job data; and
performing a second preflight of the print job data using the job attribute data collected during the first preflight based on the one or more changes.

18. The method of claim 17 wherein the second preflight is performed without having to recollect the job attribute data.

19. The method of claim 17 including data that, when accessed by the machine, further cause the machine to perform operations comprising determining whether a change is recognizable.

20. The method of claim 19 including data that, when accessed by the machine, further cause the machine to perform operations comprising performing a set of operations on the job attribute data collected during the first preflight to determine data for the second preflight upon determining that the change is recognizable.
